(19) United States
(12) Patent Application Publication
(10) Pub. No.: US 2012/0116273 A1
(43) Pub. Date: May 10, 2012

(54) FINGER-MOUNTED MASSAGE APPARATUS

(75) Inventor: Simon Siu Man Nan, Ontario (CA)

(73) Assignee: Nanma Manufacturing Co., Ltd.

(21) Appl. No.: 12/941,794

(22) Filed: Nov. 8, 2010

(51) Int. Cl. A61H 1/00

(52) U.S. Cl. 601/46

(57) ABSTRACT

A finger-mounted massage apparatus including a curved body defining a middle portion between a rear portion having a first vibratory motor and a head portion having a second vibratory motor is disclosed. The head portion and the rear portion may be configured to extend in a substantially perpendicular manner from the middle portion and in a substantially parallel manner relative to each other. The head portion may also be configured to extend more outwardly from the middle portion than the rear portion.

### FIELD

The present disclosure is directed to a massage apparatus. In particular, the disclosure is directed to a finger-mounted massage apparatus configured to simultaneously apply a massage function to different portions of a body.

### BACKGROUND

Finger-mounted massage apparatuses are known in the art. Typically, the finger-mounted apparatuses may be mounted to one or more fingers of an individual by a strap attachment so that the individual can manipulate the finger vibrator by articulating the finger for application to different parts of the body. Although finger-mounted massage apparatuses have proven satisfactory for their intended purpose, improvements in such apparatuses are still desired.

### SUMMARY

A finger-mounted massage apparatus may include a curved body having a middle portion defined between a head portion and a rear portion. A first vibratory motor is disposed within the curved body, wherein the head portion and rear portion are configured to extend in a substantially perpendicular manner from the middle portion and in a substantially parallel manner relative to each other, and wherein the head portion is configured to extend more outwardly than the rear portion from the middle portion.

A method of using a finger-mounted massage apparatus may include:

providing a finger-mounted massage apparatus including a curved body having a middle portion defined between a head portion and a rear portion, a first vibratory motor is disposed within the curved body, wherein the head portion and rear portion are configured to extend in a substantially perpendicular manner from the middle portion and in a substantially parallel manner relative to each other, and wherein the head portion is configured to extend more outwardly than the rear portion from the middle portion; and

actuating the first vibratory motor such that the head portion and the rear portion vibrate at one or more vibratory patterns.

In another embodiment, a finger-mounted massage apparatus may include a curved body having a middle portion defined between a head portion and a rear portion. A plurality of vibratory motors may be disposed inside the curved body such that at least one of the plurality of vibratory motors is disposed within the head portion and another one of the plurality of vibratory motors is disposed within the rear portion. The head portion and rear portion may extend in a substantially perpendicular manner from the middle portion and in a substantially parallel manner relative to each other. In addition, the head portion may be configured to extend more outwardly than the rear portion from the middle portion.

Additional objectives, advantages and novel features will be set forth in the description which follows or will become apparent to those skilled in the art upon examination of the drawings and detailed description which follows.

### BRIEF DESCRIPTION OF THE DRAWINGS

FIG. 1 is a perspective view of a finger-mounted massage apparatus;

FIG. 2 is a front view of the finger-mounted massage apparatus;

FIG. 3 is a rear view of the finger-mounted massage apparatus;

FIG. 4 is a side view of the finger-mounted massage apparatus;

FIG. 5 is an exploded view of the finger-mounted massage apparatus;

FIG. 6 is a cross-sectional view of the finger-mounted massage apparatus;

FIG. 7 illustrates an embodiment of the vibratory pattern produced by the finger-mounted massage apparatus;

FIG. 8 illustrates another embodiment of the vibratory pattern produced by the finger-mounted massage apparatus;

FIG. 9 illustrates yet another embodiment of the vibratory pattern produced by the finger-mounted massage apparatus;

FIG. 10 illustrates one embodiment of the vibratory pattern produced by the finger-mounted massage apparatus;

FIG. 11 illustrates a different embodiment of the vibratory patter produced by the finger-mounted massage apparatus;

FIG. 12 illustrates a further embodiment of the vibratory pattern produced by the finger-mounted massage apparatus;

FIG. 13 illustrates another embodiment of the vibratory pattern produced by the finger-mounted massage apparatus; and

FIG. 14 is a cross-sectional view of another embodiment of the finger-mounted massage apparatus showing first and second vibratory motors.

Corresponding reference characters indicate corresponding elements among the view of the drawings. The headings used in the figures should not be interpreted to limit the scope of the claims.

### DETAILED DESCRIPTION

Finger-mounted massage apparatuses are typically engaged to one or more fingers of an individual to provide a means for maneuvering and applying the massage apparatus to a body by articulation of the individual's finger(s). In addition, prior art finger-mounted massage apparatuses may include a head portion that has a vibratory component for generating a vibration function to provide a massage effect when the head portion is directly applied to the body. However, such finger-mounted massage apparatuses are incapable of applying a maximum massage effect to the different portions of the individual's body simultaneously.

As such, the finger-mounted massage apparatus and method of manufacturing such a massage apparatus as described herein improves on such finger-mounted massage apparatuses by providing a finger-mounted massage apparatus with head and rear portions configured to provide a separate vibratory effect to stimulate different portions of the individual's body, such as the sexual organs.

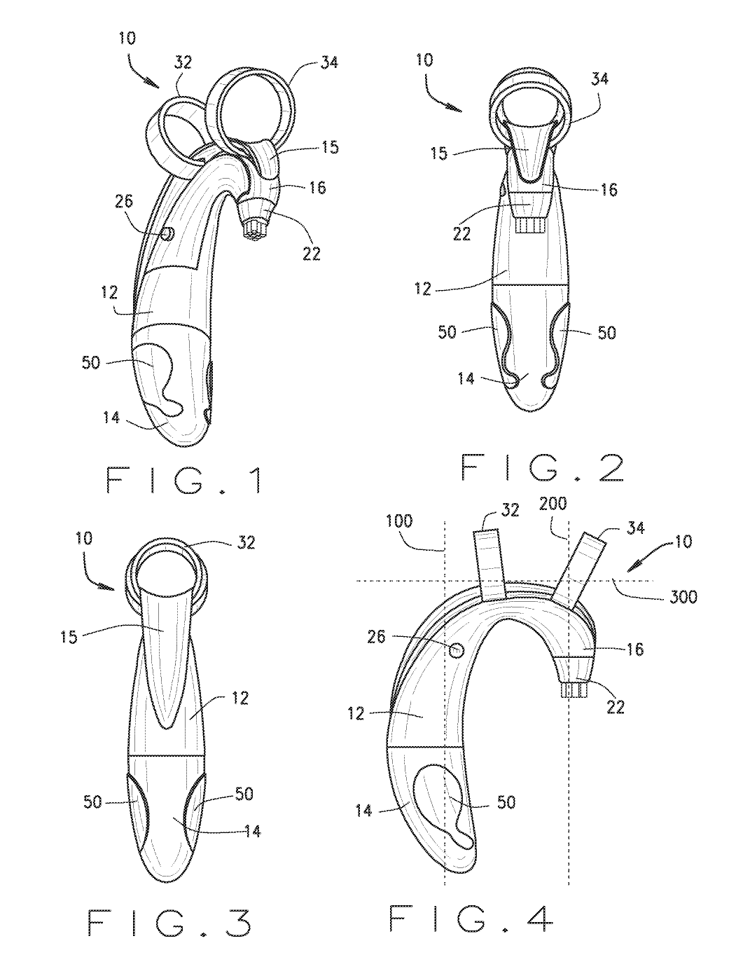

Referring to the drawings, an embodiment of the finger-mounted massage apparatus is illustrated and generally indicated as 10 in FIGS. 1-6. In general, the finger-mounted massage apparatus 10 includes a substantially C-shaped body 12 having a middle portion 15 defined between a head portion 14 and a rear portion 16. In one embodiment, the finger-mounted massage apparatus 10 may include a first vibratory motor 18 disposed inside the curved body 12 such that the curved body 12 simultaneously applies a vibratory function to the head portion 14 and rear portion 16. In one embodiment, the first vibratory motor 18 may include a rotatable shaft 56 rotationally engaged to an eccentric mass 58 capable of producing different vibratory patterns when the eccentric mass 58 is rotated as shall be disclosed in greater detail below.

Referring to FIG. 14, another embodiment of the finger-mounted massage apparatus 10 may include a dual vibratory motor arrangement having the first vibratory motor 18 and a second vibratory motor 20. In this particular embodiment, the first vibratory motor 18 is dedicated to providing a vibratory function to the head portion 14, while the second vibratory motor 20 is dedicated to providing a separate vibratory function to the rear portion 16. As such, this particular embodiment of the finger-mounted massage apparatus 10 is capable of providing simultaneous, dual vibratory functions dedicated to separate portions of the massage apparatus 10. Similar to the first vibratory motor 18, the second vibratory motor 20 may include a rotatable shaft 60 rotationally engaged to an eccentric mass 62 also capable of producing different vibratory patterns when the eccentric mass 62 is rotated.

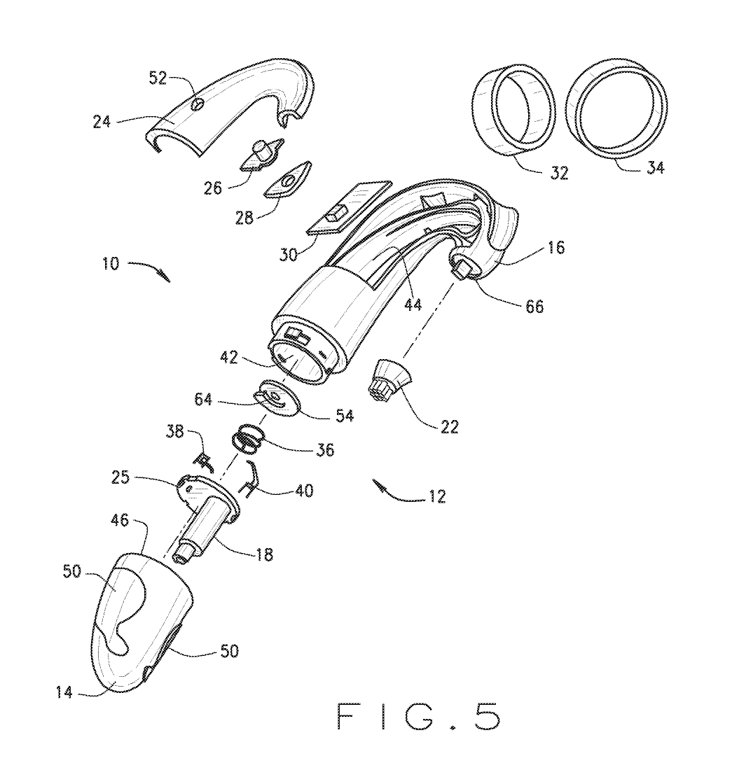

As shown in FIG. 4, the head portion 14 is oriented along a vertical axis 100, while the rear portion 16 is oriented along a second vertical axis 200 that is substantially parallel to the vertical axis 100. In addition, the middle portion 15 is oriented along a plane 300 that is substantially perpendicular to the vertical axes 100 and 200.

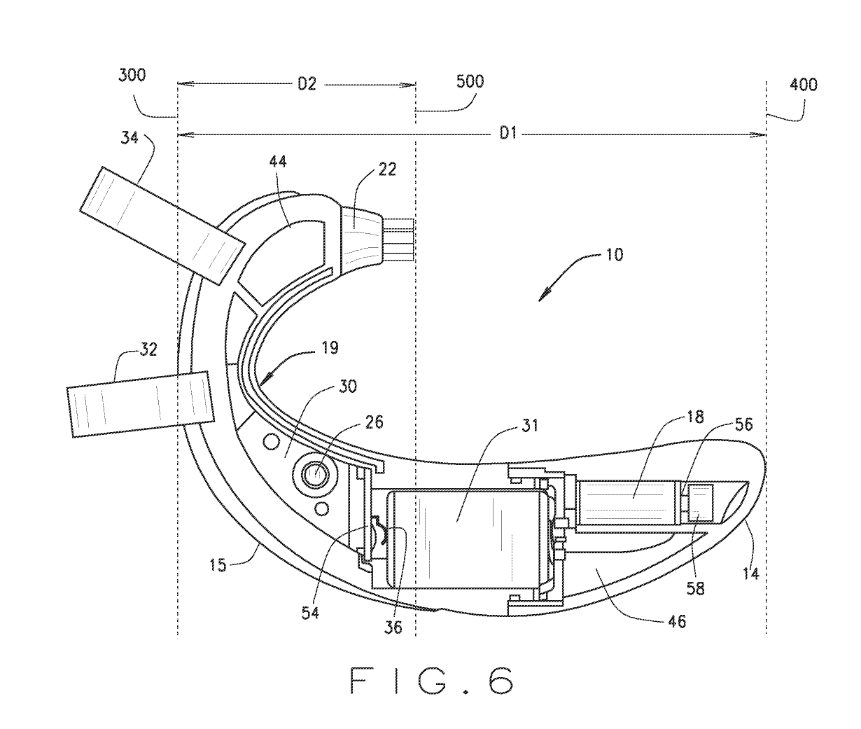

Referring to FIG. 6, in one embodiment, the head portion 14 may extend a distance D1 from the middle portion 15, which is defined as the distance between plane 300 and plane 400, while the rear portion 16 may extend a second distance D2 from the middle portion, which is defined as the distance between plane 300 and plane 500. In one embodiment of the finger-mounted massage apparatus 10, the distance D1 of the head portion 14 is always a greater distance than D2 of the rear portion 16.

In one embodiment, this structural configuration of the head portion 14, middle portion 15, and rear portion 16 of body 19 is particularly adapted to stimulate two different portions of a female's sexual organs. Specifically, the curved shaped configuration of the curved body 19 described above in which the head portion 14 extends a greater distance (e.g., D1) from the middle portion 15 than the distance (D2) that the rear portion 16 extends from the middle portion 15 permits the head portion 14 to be positioned within the vaginal area of the individual, while the rear portion 16 of the massage apparatus 10 is positioned at the same time at the individual's clitoral area. As such, the generally U-shaped configuration of the head and rear portions 14 and 16 with the head portion 14 extending farther from the middle portion 15 than the rear portion 16 permits simultaneous stimulation by the first vibratory motor 18 to the vaginal and clitoral areas of the individual.

The massage apparatus 10 may include printed circuit board 30 that controls the operation of the first vibratory motor 18 described in the first embodiment of the finger-mounted massage apparatus 10 (FIG. 6) as well as the dual vibratory motor arrangement having the first and second vibratory motors 18 and 20 described in the alternative embodiment of the finger-mounted massage apparatus 10 (FIG. 14). In one embodiment, the printed circuit board 30 may be a processor or other suitable controller adapted to generate different types of vibratory patterns by either the first and/or second vibratory motors 18 and 20.

Referring to FIGS. 5 and 6, the middle and rear portions 15 and 16 collectively define a body portion 19 that includes a rear chamber 44 and a cover 24 that encases the rear chamber 44. The head portion 14 includes a front chamber 46 that encases the first vibratory motor 18 having a base 25 that allows the motor 18 to be mounted within the head portion 14. As further shown, a positive terminal contact 38 and a negative terminal contact 40 of the first vibratory motor 18 are engaged through a base plate to establish an electrically conductive pathway to a battery 31 for providing electric power to various components of the massage apparatus 10. In one embodiment, the battery 31 may be a CR2 battery, although other types of batteries 31 may be used as a power source.

As further shown, a spiral component 54 defining a central aperture 64 is mounted within the rear chamber 46 and positioned between the battery 31 and the printed circuit board 30 which may be inserted into the rear chamber 44 through an opening 44 defined by the body 19. A spring 36 is engaged between the spiral component 54 and the battery 31 for [PLEASE PROVIDE PURPOSE OF SPRING—IS IT TO PROVIDE AN ELECTRICALLY CONDUCTIVE PATHWAY TO THE PCBA AND/OR THE VIBRATORY MOTOR OR APPLY A BIAS TO A PARTICULAR COMPONENT?].

As shown in FIG. 6, the massage apparatus 10 may include a raised finger platform 15 configured to provide a surface for the individual's finger to engage. A pair of straps 32 and 34 may also be inserted through one or more slots defined either between the finger platform 15 and the body 19 or directly through the finger platform 15 such that the individual's finger is substantially engaged between the straps 32 and 34 and the finger platform 15. In another embodiment, the finger platform 15 and straps 32 and 34 may be configured to allow more than one finger to be engaged to the massage apparatus 10.

As illustrated in FIGS. 1-5, the head portion 14 may include a pair of raised surfaces 50 that collectively form a symmetrical ornamental design. In other embodiments, the pair of raised surfaces 50 may be a non-symmetrical ornamental design having one or more raised surfaces. The pair of raised surfaces 50 may also impart a massage function by virtue of the vibrations generated by the first vibratory motor 18.

As further shown, the finger-mounted massage apparatus 10 may include a means of imparting a massage effect to the individual at the rear portion 16 of apparatus 10. The rear portion 16 may include an attachment site 66 defining a protrusion configured to engage a stimulator 22 adapted to provide a massage effect to the clitoris or other portions of the body. In one embodiment, the stimulator 22 may include a plurality of flexible extensions made from flexible material, such as rubber or flexible plastic, adapted to vibrate when either the first vibratory motor 18 and/or the second vibratory motor 20 is operational. If desired, the individual may detach the stimulator 22 and attach another type of stimulator 22 to the attachment site 66. For example, other types of stimulators 22 may include a similar flexible material, but may be configured to have a single prong, a multiplicity of prongs, or a plurality of flexible strands.

In one embodiment, the massage apparatus 10 may include a push button 26 that extends through an aperture 52 of cover 24 to actuate and control the operation of the first vibratory motor 18 alone or the combination of the first and second vibratory motors 18 and 20. In one arrangement, the push button 26 is engaged to a base plate 28 mounted on the printed circuit board 30 such that actuation of the push button 26 controls the printed circuit board 30. In one embodiment, the individual actuates the push button 26 to initiate a low vibratory level function being generated by the first vibratory motor 18 alone, or the first and vibratory motors 18 and 20 when the alternative embodiment is used, in which the vibratory pattern of any one of the vibratory motors 18 and 20 is constant. The individual may then sequentially actuate the push button 26 to raise the constant vibratory level to a medium level and then a high level of vibration. Once the high constant vibratory level is achieved sequential actuation of the push button 26 then changes the constant high level of vibratory level to a variable vibratory level in which the vibratory patterns of the first and/or second vibrators 18 and 20 are varied as shall be discussed in greater detail below.

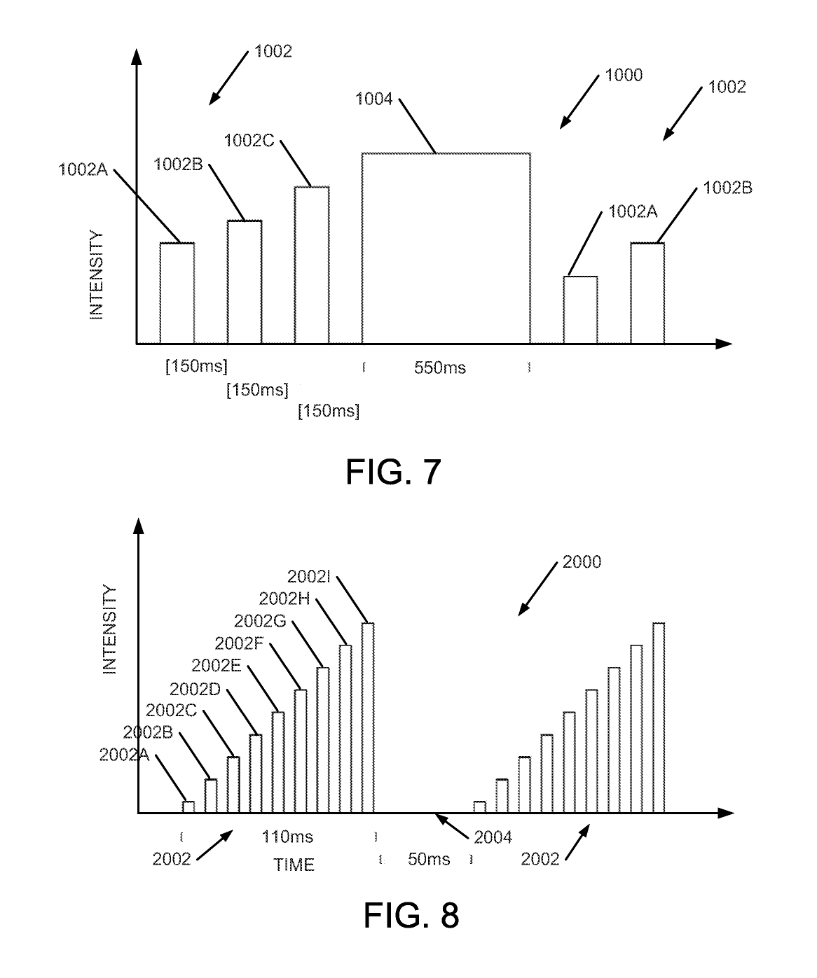

Referring to FIGS. 7-13, the printed circuit board 30 may be programmed to produce one or more vibratory patterns for either the first vibratory motor 18 alone (FIG. 6) or each of the first and second vibratory motors 18 and 20 (FIG. 14) during operation of the massage apparatus 10. In one embodiment, the printed circuit board 30 may apply the same vibratory patterns simultaneously to the first and second vibratory motors 18 and 20, respectively, or different vibratory patterns simultaneously to the first and second vibratory motors 18 and 20.

In one embodiment of the vibratory pattern shown in FIG. 7, a vibratory pattern 1000 may include a plurality of identical rectangular-shaped pulses 1002A-C that are timed to be initiated every 150 milliseconds while also sequentially increasing in vibratory intensity, which is followed by a single rectangular-shaped pulse 1004 having a greater intensity (e.g., greater intensity than the rectangular-shaped pulse 1004) with a duration of 550 milliseconds. As such, the vibratory pattern 1000 may include the plurality of pulses 1002 followed by pulse 1004 with this pattern being repeated.

In another embodiment of the vibratory pattern shown in FIG. 8, a vibratory pattern 2000 may include a plurality of identical rectangular-shaped pulses 2002A-20021 that are generated in a duration of 100 milliseconds with each successive pulse 2002 being greater is intensity that the previous pulse 2002. The plurality of pulses 2002 may be followed by a pause 2004 having a 50 millisecond duration, before the pulses 2002A-1 are repeated again. In other embodiments, the number of pulses 2002 may vary.

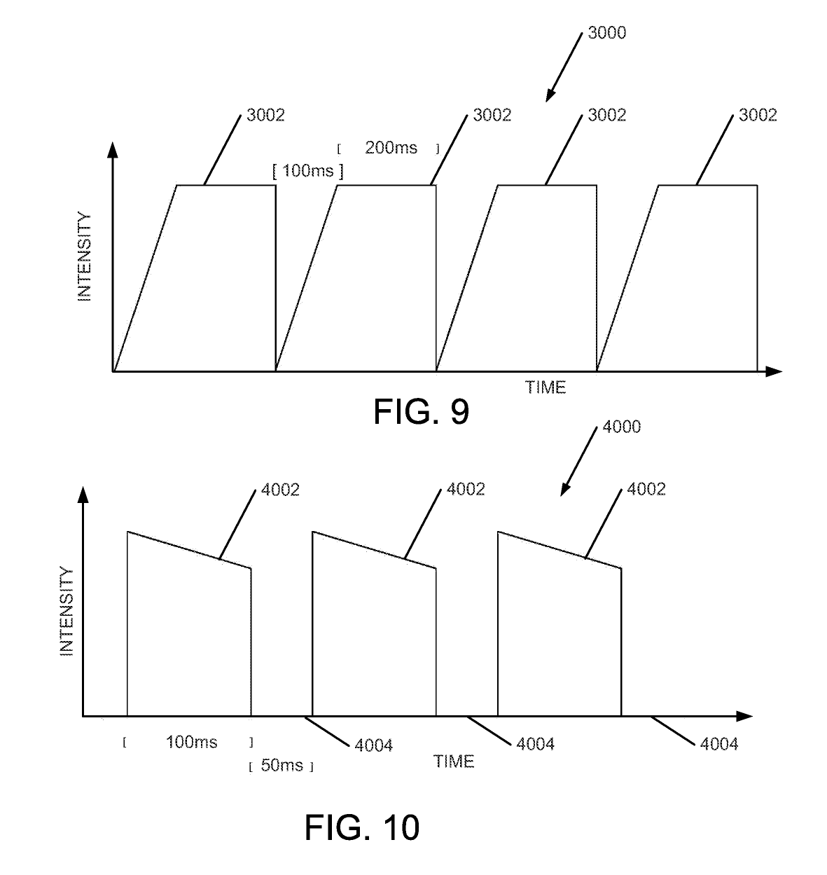

In one embodiment of the vibratory pattern shown in FIG. 9, a vibratory pattern 3000 may include a plurality of identical pulses 3002 that each linearly rise in intensity before leveling off at a particular intensity level for 200 milliseconds. The pulse 3002 then drops off sharply to a lower or no intensity level before again linearly rising to the same intensity with a duration of 100 millisecond between the pulse 3002 dropping sharply off and then rising to that same intensity level.

In yet another embodiment of the vibratory pattern shown in FIG. 10, a vibratory pattern 4000 may include a plurality of successive identical pulses 4002 that each sharply rise to a predetermined intensity and then linearly lower in intensity before the pulse 4002 sharply drops off to a lower or no intensity level before the pulse 4002 repeats itself again after a pause 4004 of 50 milliseconds. The duration of the pulse 4002 may be 100 milliseconds between each pause 4004.

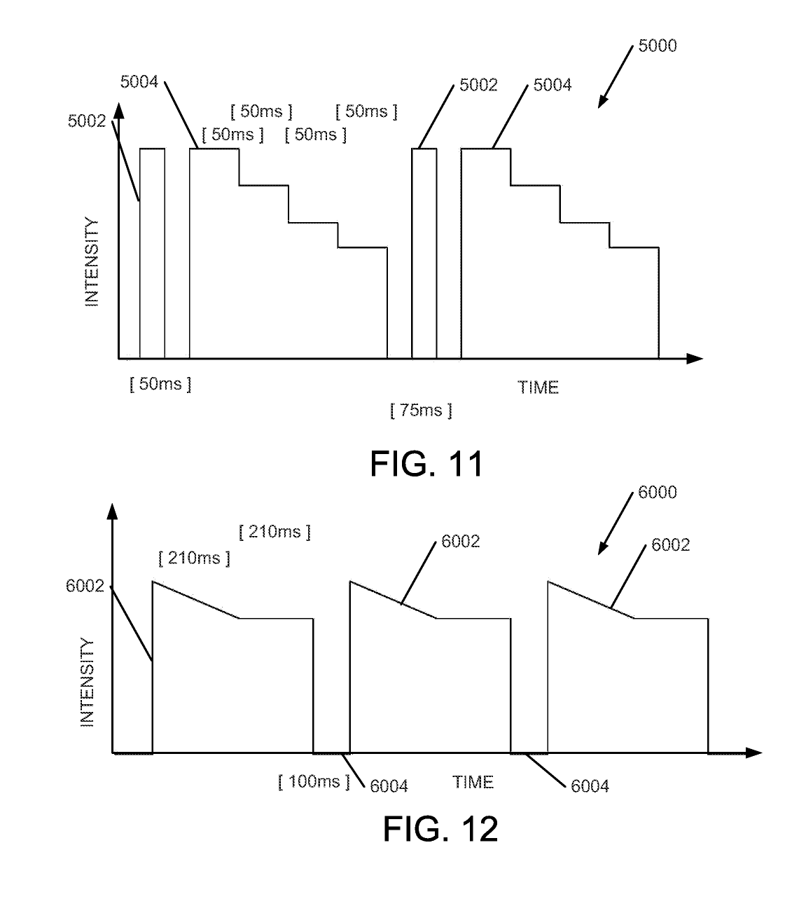

In a further embodiment of the vibratory pattern shown in FIG. 11, a vibratory pattern 5000 may include two different types of pulses 5002 and 5004 that follow a specific pattern of vibration. For example, pulse 5002 is a rectangular-shaped pulse that sharply rises to a predetermined intensity before sharply dropping off to a lower or no intensity level before pulse 5004 sharply rises to the same intensity level for a 50 millisecond duration before dropping to another lower predetermined intensity level for a 50 millisecond duration. This stepped drop in intensity level is repeated three times before the pulse 5004 drops to the same lower or no intensity level. Once the pulse 5004 drops to the lower or no intensity level, the vibratory pattern 5000 is repeated again. The duration between the initiation of pulse 5002 and pulse 5004 may be 50 milliseconds, while the duration between the end of pulse 5004 and the beginning of another pulse 5004 may be 75 milliseconds.

In one embodiment of the vibratory pattern shown in FIG. 12, vibratory pattern 6000 may include a plurality of pulses 6002 separated by a pause 6004. As shown, the pulse 6002 may sharply rise to a predetermined intensity level before linearly lowering to another predetermined intensity level over the duration of 210 milliseconds. The pulse 6002 then maintains that intensity level for the duration of another 210 milliseconds before dropping off sharply to a pause having a lower or no intensity level for 100 milliseconds.

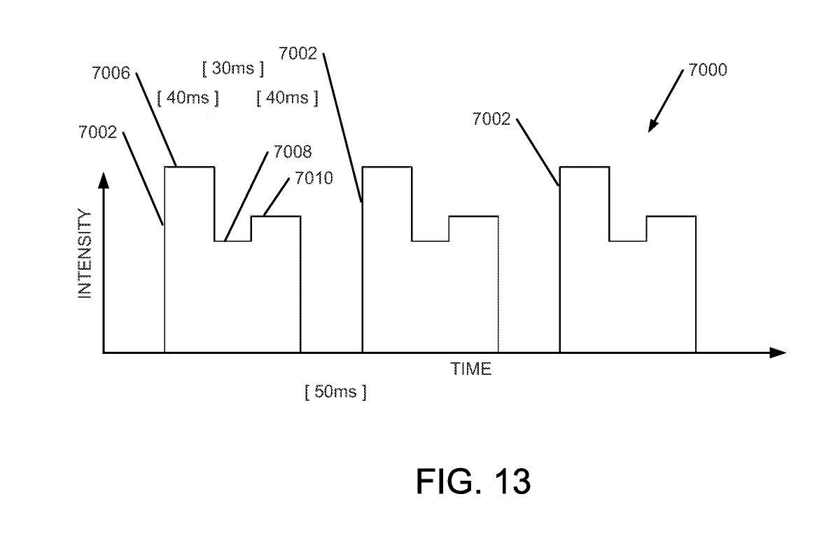

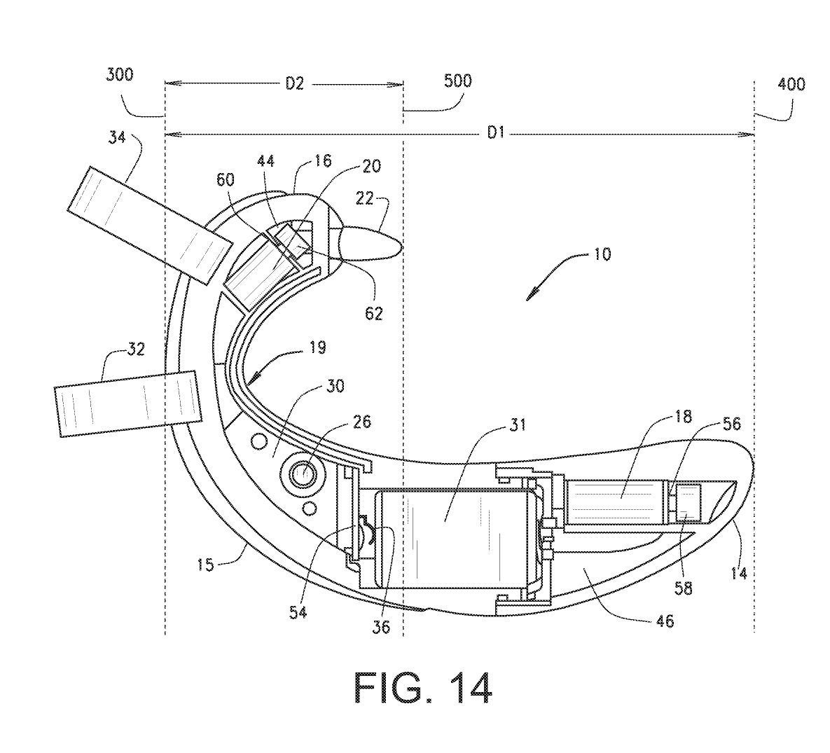

In another embodiment of the vibratory pattern shown in FIG. 13, vibratory pattern 7000 may include a plurality of successive pulses 7002 with a pause 7004 spaced between each pulse 7002. As shown, the pulse 7002 may have a first portion 7006 that sharply rises to a predetermined intensity level and remains at that particular intensity level for 40 milliseconds before sharply dropping to second portion 7008 having a lower intensity level for 30 milliseconds. The pulse 7002 then rises again to a third portion 7010 for 40 milliseconds having an intensity level that falls between the first portion 7006 and second portion 7008 before dropping to an even lower or no intensity level having a pause that lasts for 50 milliseconds before the pulse 7002 repeats again.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A finger-mounted massage apparatus comprising:
a curved body having a middle portion defined between a head portion and a rear portion; and
a first vibratory motor being disposed within the curved body; and
wherein the head portion and rear portion are configured to extend in a substantially perpendicular manner from the middle portion and in a substantially parallel manner relative to each other, and wherein the head portion is configured to extend more outwardly from the middle portion than the rear portion.

2. The finger-mounted massage apparatus of claim 1, further comprising at least one strap connected to the curved body.

3. The finger-mounted massage apparatus of claim 2, wherein the at least one strap is a pair of first and second straps.

4. The finger-mounted massage apparatus of claim 2, wherein the curved body defines at least one slot configured to engage the at least one strap.

5. The finger-mounted massage apparatus of claim 1, further comprising:
a printed circuit board in operative communication with the first vibratory motor for controlling the operation of the first vibratory motor and the second vibratory motor.

6. The finger-mounted massage apparatus of claim 5, wherein the printed circuit board controls the first vibratory such that the first vibratory motor functions to generate one or more vibratory patterns.

7. The finger-mounted massage apparatus of claim 5, further comprising:
a push button in operative communication with the printed circuit board for controlling the operation of the first vibratory motor.

8. The finger-mounted massage apparatus of claim 1, further comprising:
a battery for supplying power to the first vibratory motor.

9. The finger-mounted massage apparatus of claim 1, further comprising:
a stimulator mounted on the rear portion for providing a massage effect when the first vibratory motor is made operational.

10. The finger-mounted massage apparatus of claim 9, wherein the stimulator defines at least one flexible prong that extends from the rear housing.

11. The finger-mounted massage apparatus of claim 1, further comprising:
at least one chamber defined by the curved body configured to receive the first vibratory motor.

12. The finger-mounted massage apparatus of claim 11, further comprising:
a spiral component engaged to a spring mounted within the at least one chamber for establishing a conductive pathway between a battery and the first vibratory motor.

13. The finger-mounted massage apparatus of claim 1 further comprising:
a second vibratory motor for providing a vibratory function, the second vibratory motor being disposed in the rear portion and the first vibratory motor being disposed in the head portion, wherein the first vibratory motor and the second vibratory motor function to generate one or more vibratory patterns.

14. A finger-mounted massage apparatus comprising:
a curved body having a middle portion defined between a head portion and a rear portion; and
a plurality of vibratory motors disposed inside the curved body such that at least one of the plurality of vibratory motors being disposed within the head portion and another one of the plurality of vibratory motors being disposed within the rear portion;
wherein the head portion and rear portion are configured to extend in a substantially manner from the middle portion and in a substantially parallel manner relative to each other, and
wherein the head portion is configured to extend more outwardly from the middle portion than the rear portion.

15. The finger-mounted massage apparatus of claim 14, wherein the curved body defines at least one slot configured to engage at least one strap.

16. The finger-mounted massage apparatus of claim 14, further comprising:
a printed circuit board in operative communication with the plurality of vibratory motors for controlling the operation of the plurality of vibratory motors.

17. The finger-mounted massage apparatus of claim 16, wherein the printed circuit board controls the plurality of vibratory motors such that each respective plurality of vibratory motors functions to generate one or more vibratory patterns.

18. The finger-mounted massage apparatus of claim 16, further comprising:
a push button in operative communication with the printed circuit board for controlling the operation of the plurality of vibratory motors.

19. The finger-mounted massage apparatus of claim 14, further comprising:
a stimulator mounted on the rear portion for providing a massage effect.

20. A method of using a finger-mounted massage apparatus comprising:
providing a finger-mounted massage apparatus including a curved body having a middle portion defined between a head portion and a rear portion, a first vibratory motor is disposed within the curved body, wherein the head portion and rear portion extend from the middle portion in a substantially perpendicular manner such that the head portion and the rear portion extend from the middle portion in a substantially parallel manner relative to each other, and wherein the head portion extends more outwardly from the middle portion than the rear portion; and
actuating the first vibratory motor such that the head portion and the rear portion vibrate at one or more vibratory patterns.
